(19) United States
(12) Patent Application Publication
(10) Pub. No.: US 2002/0080942 A1
(43) Pub. Date: Jun. 27, 2002

(54) Origin-independent custom caller ID

(76) Inventor: Edward O. Clapper, Tempe, AZ (US)

Correspondence Address: Richard C. Calderwood, BLAKELY, SOKOLOFF, TAYLOR & ZAFMAN, LLP, 7th Floor, 12400 Wilshire Boulevard, Los Angeles, CA, 90025, US

(21) Appl. No.: 09/745,703

(22) Filed: Dec. 21, 2000

(51) Int. Cl. H04M 3/42; H04M 1/56

(52) U.S. Cl. 379/201.01; 379/207.13; 379/142.01

(57) ABSTRACT

Apparatus and method for causing custom ID information to be presented at a second communication device upon a communication from a first communication device. For example, a custom caller ID service which enables a caller to present a personal caller ID rather than the caller ID of the phone from which they happen to be calling. The invention has application outside telephony as well, such as, for example, in internet and instant messaging.

### RELATED APPLICATIONS

This application is related to application Ser. No. ______,filed concurrently herewith by the same inventor, and entitled “Message Card”.

### BACKGROUND OF THE INVENTION

1. Technical Field of the Invention

The present invention relates generally to the field of communications technologies in which a first entity initiates a contact to a second entity, and more specifically to technologies in which the second entity receives an identification of the first entity.

2. Background Art

One exemplary such technology exists in the telephone system, and is known as “caller ID”. When a person places a telephone call from a first telephone to a second telephone, the telephone system sends to the second telephone an identification (the telephone number) of the first telephone. This identification can be utilized by equipment at the second telephone in a variety of ways. One common example is that the telephone number is simply displayed on the second telephone or on a device connected to the second telephone. The called person can use this number in deciding whether to answer the call. In some implementations, the identification is used in providing additional or more useful information at the second telephone, such as by looking up the caller's number in a “speed dial” or other such directory at the second telephone, and, if a match is found, presenting the caller's name instead of or in addition to the caller's number. As another example, the called person's telephone may block incoming calls from particular numbers, or may block incoming calls from numbers for which the caller ID is not presented.

This is a useful mechanism, and commercially desirable. However, the existing technology is focused on presenting an identification of the calling device, rather than the calling person.

### BRIEF DESCRIPTION OF THE DRAWINGS

The invention will be understood more fully from the detailed description given below and from the accompanying drawings of embodiments of the invention which, however, should not be taken to limit the invention to the specific embodiments described, but are for explanation and understanding only.

FIG. 1 shows one embodiment of a system utilizing this invention, in which the personal ID service is part of the communications system itself.

FIG. 2 shows another embodiment of a system utilizing this invention, in which the personal ID service is a stand-alone entity, separate from the communications system itself.

FIG. 3 shows one embodiment of a method such as may be used by the system of FIG. 1.

FIG. 4 shows one embodiment of a method such as may be used by the system of FIG. 2.

FIG. 5 shows one embodiment of a message card.

FIG. 6 shows one embodiment of a method such as may be used in conjunction with the message card of FIG. 5.

### DETAILED DESCRIPTION

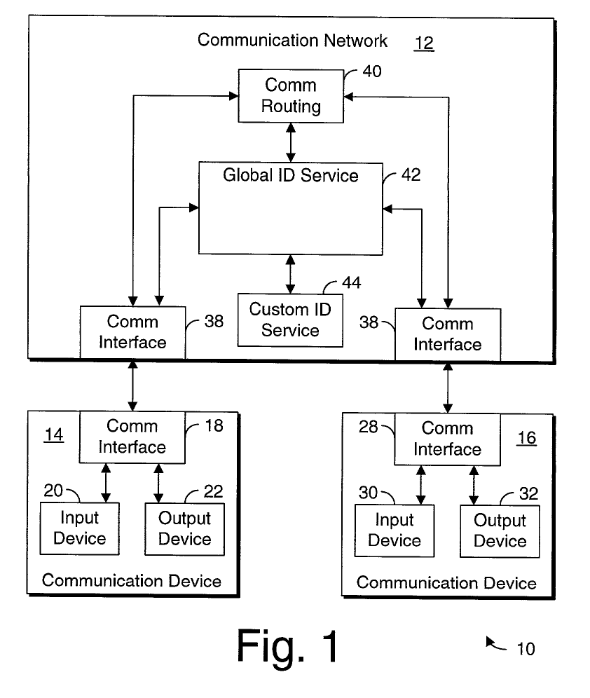

FIG. 1 illustrates a system 10 including a communication network 12, and a first communication device 14 and a second communication device 16 coupled to the communication network. Typically, the system may include an arbitrarily large number of such communication devices; only two are shown here, for simplicity.

The first communication device includes a communication interface 18 via which the communication device is coupled to the communication network. It further includes, in some embodiments, an input device 20 and an output device 22, coupled to the communication interface. The second communication device includes a communication interface 28 for connecting the device to the communications network, and in some embodiments, an input device 30 and an output device 32, coupled to the communication interface. The input and output devices may be any suitable mechanism, as indicated for the chosen application. In various embodiments, the input device may be a keyboard, key pad, touch screen, microphone, menu, command line interface, or any other suitable means. In various embodiments, the output device may be a speaker, a display screen, or any other suitable means. Other components of the communications devices, such as processors and power supplies, are omitted from this discussion in the interest of clarity, but the skilled reader will readily appreciate their presence and connection to the other shown components.

The communication network includes one or more communication interfaces 38 for connecting to the communication devices. It further includes a communication routing mechanism 40 which directs communications from one communication device to a desired one(s) of the possibly myriad other communications devices. The communication routing mechanism may be a circuit-switched system, a packet-switched system, or other suitable mechanism. The communication network may include a communications pathway (not shown) which is based on electrical, magnetic, optical, or other suitable mechanism, and which may be embodied as a backbone, a LAN, a WAN, a wireless connection, an optical connection such as via a laser, a satellite system, or other suitable configuration, and which may be implemented according to an internet protocol addressing scheme, a telephone number based addressing scheme, or any other means suitable for the application.

The communication network further includes an ID service 42 which provides the identification of one communication device to another communication device. In one embodiment, the communication network may be a telephone network, and the global ID service may be the set of services and mechanisms which provide “caller ID”. In another embodiment, the communication network may be the internet, and the global ID service may be the set of services and mechanisms which support “instant messaging”. In other embodiments, the communication network may be a wireless PDA or pager network or the like.

In addition to the global ID service, the communication network includes a custom ID service 44. The functionality of the custom ID service will be described in detail below. In various embodiments, the custom ID service may be constructed as a separate entity from the global ID service, while in others, it may be constructed as a sub-service within the global ID service.

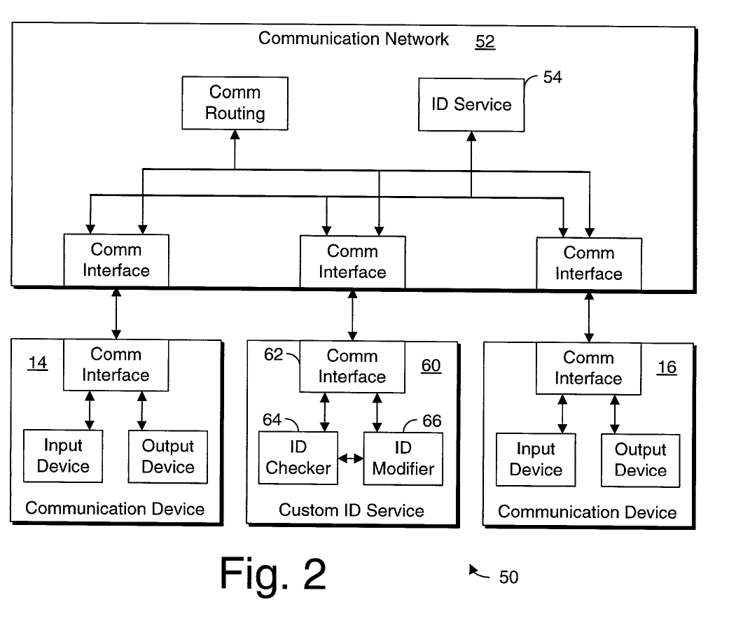

FIG. 2 illustrates one embodiment of a differently-configured system 50 utilizing this invention. The system includes a communication network 52 which includes communications interfaces for connecting to a plurality, and typically a large number, of communications devices. The communication network includes a communication routing mechanism and a conventional ID service 54. The communication network may be constituted in a manner similar to that of the communication network of FIG. 1, except that the ID service 54 does not necessarily include a custom ID service; it may include one (not shown), but is not required to include one.

In this embodiment, the communication network is coupled to a first communication device 14 via which a user desires to communicate with a second communication device 16 coupled to the communication network. In this embodiment, there is a third communication device 60, in which the custom ID service is embodied, coupled to the communication network.

The custom ID service includes a communication interface 62 for connecting to the communication network. The custom ID service also includes an ID checker 64 and an ID modifier 66 which may be coupled to the communication interface and/or to each other.

The skilled reader will appreciate that, in various embodiments, the respective communications devices may be coupled to the communication network via different types of connection means with correspondingly different communication interfaces. For example, the first communication device 14 may be connected via a twisted-pair telephone wire, the personal ID service 60 may be connected via a coaxial cable modem, and the second communication device 16 may be connected via a cellular wireless link. Furthermore, the reader will appreciate that the respective connections between the communications devices and the communication network need not necessarily be direct connections. For example, in the case of a cellular connection, the connection may go through a variety of cellular stations, terrestrial links, microwave relays, and so forth, before ultimately connecting to a backbone or the like of the communication network.

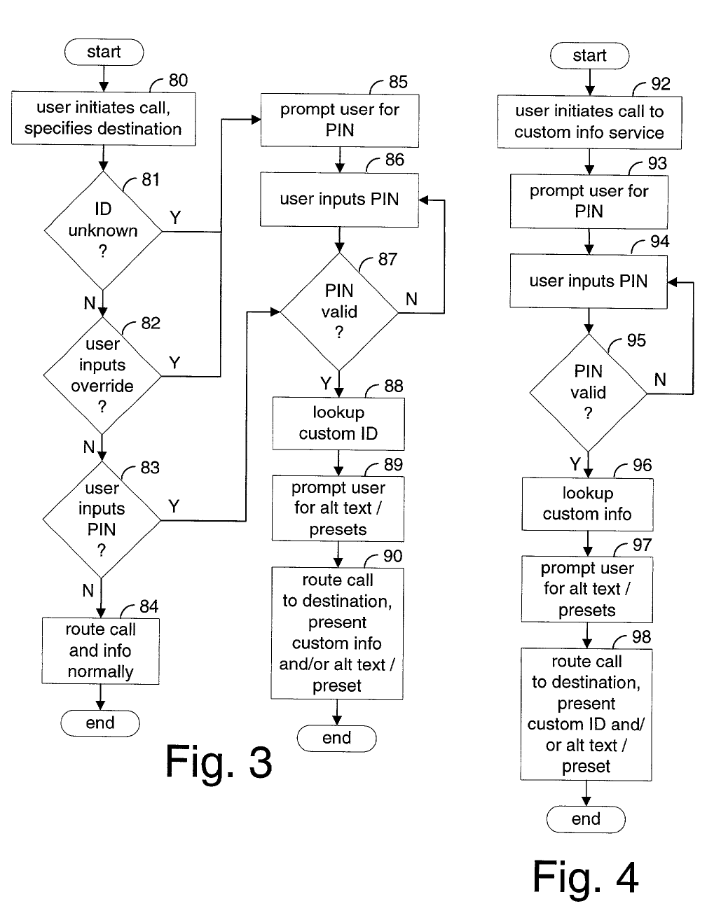

FIG. 3 illustrates one embodiment of a method of the operation of the system of FIG. 1, to which the reader should also make reference. The method will be explained with reference to a “caller ID” embodiment, but the reader will appreciate that this is by way of illustration and not limitation. The method begins with a user initiating a call to a specified destination (80). If (81) the user is calling from a phone with an unknown or indeterminate caller ID, or if (82) the user inputs a command to indicate that she wishes to override the default caller ID of that phone, the system prompts (85) the user for her personal identification number (PIN) or other suitable identification, which the user inputs (86) through the phone's input device (20). She may do this by entering her PIN on the phone's keypad, or by speaking her pin or password into the telephone system's voice recognition system (not shown), by swiping her calling card through the phone's credit card slot, or the like.

In some embodiments, the system may enable the user to skip some of those steps by simply inputting her PIN (83). In some embodiments, if the user does none of those, the invention is not invoked, and the system routes the call normally and provides its usual caller ID information (84) to the destination phone.

But if the invention is invoked, the custom ID service may require (87) that the user enter a valid PIN or the like. Depending upon the level of security and verifiability which the application requires, the custom ID service may implement various types and degrees of security. In some cases, it may be sufficient that the user has entered a unique PIN number. In other cases, the custom ID service may permit invocation of the method at only pre-determined ones of the communications devices, and not at others (such as pay phones, perhaps). In other cases, it may be sufficient that the user is in physical possession of the calling card. In other cases, there may be strong encryption, voice recognition, multiple levels of authentication, and other such technologies employed.

If the user inputs a valid PIN or other such identifying information, the custom ID service may look up (88) the user's custom ID information in a database (not shown). The custom ID service may optionally (89) prompt the user to enter alternative information to that stored as the user's default. This may include enabling the user to pick from one or more preset sets of custom ID information. Those may be configurable by the user, or they may be set by the custom ID service.

Ultimately (90), the call is routed to the specified destination, and the system presents the user's selected custom ID information (whether that be the default, preset, or newly-entered information) to the destination phone.

Take the example where Alice is at Betty's house and wishes to phone Carla, but she knows that Carla will not answer the phone if her caller ID screen says the call is from Betty. This invention enables Alice to override this default condition, and cause the system to present Alice's custom ID information on Carla's phone. Alice may cause Carla's phone to present, for example: “Alice”, or Alice's home phone number “(505) 555-1313”, or “Alice coming to visit you”, or whatever she wishes.

FIG. 4 illustrates one exemplary method of operating the system of FIG. 2, to which the reader should also make reference. The method begins (92) with the user (at phone 14) initiating a call not directly to the ultimate destination phone (16), but rather to the phone number of the custom ID service provider (60). The custom ID service prompts (93) the user for her PIN, which the user provides (94), and the custom ID service validates (95). Once a valid identity has been established, the custom ID service may (96) lookup the user's custom ID information in a database (not shown), and may prompt the user for alternative text, which may include one or more preset messages (97). Once the custom ID information has been selected, the custom ID service re-routes the call, such as by (98) conferencing it or forwarding it, to the destination phone, providing with the call the custom ID information.

In some embodiments, it may be desirable or necessary for the custom ID service to cooperate or negotiate with the communication network. For example, in some embodiments, the communication network might otherwise present the custom service ID service's caller ID, rather than the calling person's custom ID information, to the recipient—unless the communication network and custom ID service have an arrangement to enable the substitution of the desired information. The reader will appreciate that this negotiation may be necessary in order to, e.g., protect the interests of the communication network and prevent fraud on its customers.

The skilled reader will appreciate that the flowcharts of FIGS. 3 and 4 illustrates but two example of methods by which such systems may operate, and that there are many alternative possibilities. In some other embodiments, various ones of the steps may be left out, or may be reordered, or may be enhanced with additional steps and technologies, yet remain within the scope of this invention. In some embodiments, the custom ID information might be e.g. pre-pended to the normal caller ID information, rather than strictly replacing it.

The user will further appreciate that the operation of the communication network, the calling phone, and/or the called phone may be altered in response to the usage of custom ID info. For example, the called phone or the communication network may be pre-programmed to present a different ringing tone in response to calls bearing predetermined custom ID information. As another example, the communication network might log or even record all custom ID info calls, or those bearing selected custom ID info, such as for law enforcement purposes. As another example, the calling phone may disable certain of its features in response to usage of custom ID information, such as its speed-dial buttons or data. As another example, the communication network might charge a different toll rate for custom ID calls, or for custom ID blocking or unblocking, or the like.

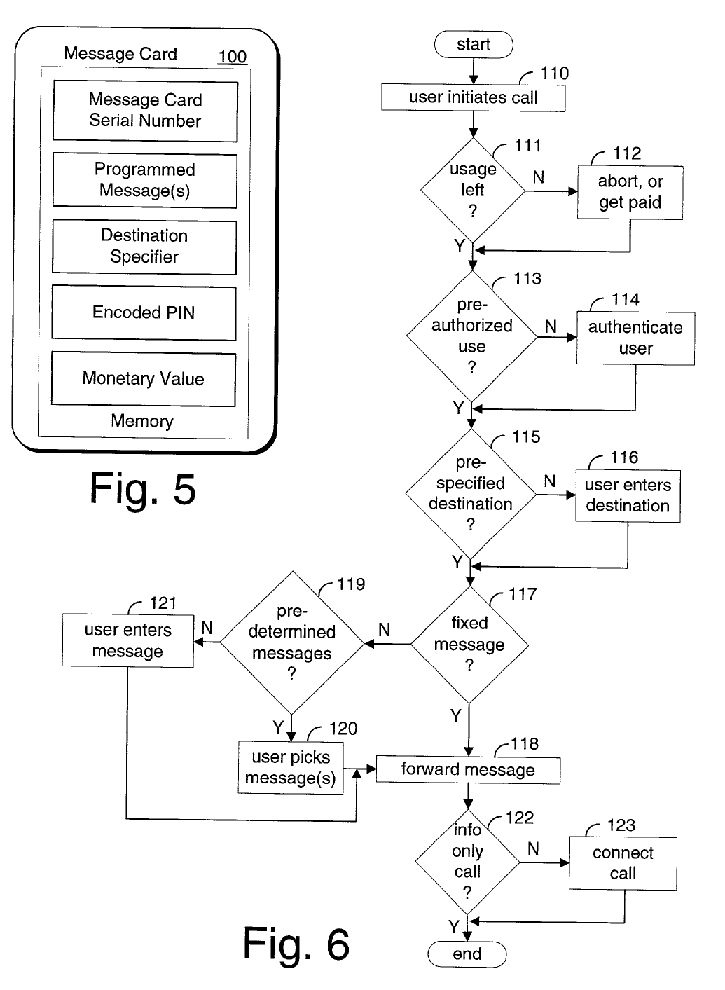

FIG. 5 illustrates another embodiment, in which the custom ID information or messages may be pre-programmed into a “message card” 100 (or into the custom ID service for use with a uniquely-identified message card), which could be sold to a user; the user might phone the destination phone or the custom ID service, swipe the message card or enter its serial number, and the custom ID service might in response cause the destination phone to display e.g. “I love you” or “I have left the office, home soon” or what have you; it might even do this without the regular voice portion of the call being completed, resulting in a “call-less call” which transmits only the custom ID information.

The message card includes a memory, such as a magnetic stripe or, in the case of a “smart card”, a semiconductor memory device. The memory may include a unique identifier such as a serial number, to enable the custom ID service to prevent fraud from unauthorized duplicate cards. The memory may further include one or more programmed message. In some embodiments, these may be pre-programmed messages. In other embodiments, the user may be allowed to program all or some of the messages. In some embodiments, the messages may be stored at the custom ID service rather than on the card itself. The message card may further include a programmed destination specifier such as a phone number. In some embodiments, this may be a pre-programmed number, while in other embodiments, the user may program it, or the purchaser may have it programmed at the time and point of sale; this may be used by, for example, a parent who purchases an “I am alive and well but too broke to write or call” card for his college student child. In some embodiments, the number may be stored at the custom ID service rather than on the card. The message card may further include a PIN or other security mechanism. In some embodiments, it may be encoded. The message card may further include a monetary value specifier which indicates a remaining money balance on the card, or a remaining number of pre-paid usages, or the like; this may in some embodiments be pre-programmed, while in others it may be left for programming e.g. at the time and point of sale. In the embodiments where various of the data are stored at the custom ID service, they will be indirectly accessed in response to the unique identifier from the card.

FIG. 6 illustrates one embodiment of a method of operating a system, such as that of FIG. 1 or FIG. 2, in conjunction with the message card of FIG. 5. The operation begins with the user initiating a call (110). If (111) the message card is used up, or, in other words, if there are no remaining calls or minutes or money on the card, then the operation may terminate (112) unless the user pre-pays for additional usage, such as by authorizing a credit card charge or the like. If there is pre-paid usage remaining or newly authorized, then if (113) the message card requires user authentication or, in other words, if possession of the card is not sufficient, then the user is authenticated (114) such as by entering a password or PIN. Once the usage has been authorized, then if (115) the calling destination is not pre-specified, the user enters the calling destination (116) such as via the phone's keypad.

If (117) the card specifies a fixed message, that message is sent (118). In some embodiments, the fixed message may be printed on the face of the card. If, however, there is no fixed message, then if (119) there are one or more predetermined messages from which the user may select, the user selects (120) one or more of the predetermined messages, which are sent (118). Some or all of the predefined messages may be printed on the card, and the user may select one or more of them, such as by entering their number(s) on the keypad or other suitable entry means. If there are no predetermined messages, the user manually enters (121) the message such as by entering it into the keypad or by speaking it to a voice recognition system or to an operator, and the message is sent (118) to the destination communication device. In another embodiment, the list of predetermined messages may include a “tbd” message which, when selected by the user, causes the system to prompt the user and enable the user to manually enter a non-predetermined message. If (122) the communication is to also include conventional usage of the communication devices, such as a spoken phone call, then the call is connected (123) from the calling phone to the destination phone.

While the invention has been described with reference to a “caller ID” service within a telephone network, the user will appreciate that it may be applied to other applications.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. A method comprising:
receiving a communication from a first communication device, the communication having associated therewith a first identifying information;
authenticating a user of the first communication device; and
replacing the first identifying information with second identifying information.

2. The method of claim 1 further comprising:
retrieving the second identifying information as a function of an identity of the user as authenticated.

3. The method of claim 1 further comprising:
receiving the second identifying information from the user via the first communication device.

4. The method of claim 3 further comprising:
prompting the user to enter the second identifying information.

5. The method of claim 1 further comprising:
providing to the user via the first communication device a plurality of predetermined sets of alternate identifying information; and
receiving from the user a selection of one of the predetermined sets of alternate identifying information to use as the second identifying information.

6. The method of claim 1 wherein authenticating the user comprises:
receiving from the user via the first communication device authentication data; and
comparing the authentication data against a set of known-authentic data.

7. The method of claim 6 wherein the authentication data comprise a PIN.

8. The method of any of claims 1-7 further comprising:
connecting the communication to a second communication device; and
presenting the second identifying information to the second communication device.

9. The method of any of claims 1-7 wherein:
the method is performed in a telephone network;
the first identifying information comprises caller ID information; and
the method further comprises,
connecting the communication to a second communication device, and presenting the second identifying information to the second communication device.

10. A method comprising:
receiving a communication from a first communication device;
authenticating a user of the first communication device;
pursuant to authentication of the user, selecting custom ID information;
connecting the communication from the first communication device to a second communication device; and
delivering the custom ID information to the second communication device.

11. The method of claim 10 further comprising:
receiving from the user a first input to override a first ID information associated with the first communication device; and
the delivering of the custom ID information replaces the first ID information with the custom ID information.

12. The method of claim 10 wherein the authenticating of the user comprises:
receiving from the user a second input which the user has entered at the first communication device; and
comparing the second input against a set of known-valid data.

13. The method of claim 10 further comprising:
receiving from the user a third input to select the custom ID information from a plurality of pre-determined data.

14. The method of claim 10 further comprising:
receiving the custom ID information from the user via the first communication device.

15. The method of any of claims 10-14 wherein the method is performed in a caller ID service of a telephone network.

16. A method for use in a communication system which includes, coupled to a communication network, a first communication device, a second communication device, and a custom ID service, the method comprising the custom ID service:
receiving a communication from the first communication device via the communication network;
receiving authentication data from the first communication device via the communication network;
validating the authentication data;
connecting the communication to the second communication device via the communication network; and
presenting custom ID information to the second communication device via the communication network.

17. The method of claim 16 further comprising:
looking up the custom ID information as a function of the authentication data.

18. The method of claim 16 further comprising:
prompting the user to enter the custom ID information; and
receiving the custom ID information from the first communication device via the communication network.

19. The method of claim 16 further comprising:
receiving from the first communication device via the communication network a selection of one of a plurality of predetermined sets of custom ID information.

20. The method of any of claims 16-19 wherein the communication network comprises a telephone network and the custom ID service negotiates with the telephone network to cause the telephone network to deliver the custom ID information as caller ID information.

21. An apparatus for use with first and second communication devices, the apparatus comprising:
a plurality of communication interfaces through which the communication devices can connect to the apparatus;
a communication routing mechanism, coupled to the plurality of communication interfaces, for connecting the first communication device to the second communication device;
a global ID service, coupled to the communication routing mechanism, for delivering to the second communication device data identifying the first communication device; and
a custom ID service, coupled to the global ID service, for providing custom ID information for delivery to the second communication device.

22. The apparatus of claim 21 wherein the custom ID service comprises:
means for authenticating a user of the first communication device.

23. The apparatus of claim 22 wherein the custom ID service further comprises:
means for selecting the custom ID information in response to data identifying the authenticated user.

24. The apparatus of claim 22 wherein the custom ID service further comprises:
means for receiving the custom ID information from the user.

25. The apparatus of claim 24 wherein the means for receiving the custom ID information comprises:
means for prompting the user to select the custom ID information from a plurality of predetermined sets of data; and
means for receiving a selection from the user.

26. The apparatus of any claim 21-25 wherein the global ID service comprises a caller ID mechanism and the custom ID information is presented in lieu of caller ID info which would otherwise have been presented for the first communication device.

27. An apparatus for use with a communication network having a communication routing mechanism for connecting a communication from a first communication device to a second communication device and having an ID service for providing to the second communication device first ID information associated with the first communication device, the apparatus comprising:
means for coupling to the communication network to receive a communication from the first communication device;
means for authorizing usage of the apparatus; and
means for providing custom ID information to the communication network for the communication network to provide to the second communication device.

28. The apparatus of claim 27 wherein the means for authorizing comprises:
means for receiving a first input data from the first communication device; and
means for comparing the first input data against a plurality of pre-validated data.

29. The apparatus of claim 27 wherein the means for providing custom ID information comprises:
means for looking up the custom ID information in response to data from the means for authorizing.

30. The apparatus of claim 27 wherein the means for providing custom ID information comprises:
means for receiving the custom ID information from the first communication device.

31. The apparatus of claim 27 wherein the means for providing custom ID information comprises:
means for prompting a user of the first communication device to select the custom ID information from a plurality of predetermined data; and
means for receiving the user's selection.
